(19) United States
(12) Patent Application Publication
(10) Pub. No.: US 2013/0083228 A1
(43) Pub. Date: Apr. 4, 2013

(54) IMAGE CAPTURING DEVICE, METHOD FOR CONTROLLING IMAGE CAPTURING DEVICE, AND PROGRAM USED IN CONTROL METHOD

(71) Applicant: Toshihiko Iwatani, Hyogo (JP)

(72) Inventor: Toshihiko Iwatani, Hyogo (JP)

(73) Assignee: PANASONIC CORPORATION, Osaka (JP)

(21) Appl. No.: 13/703,461

(22) PCT Filed: Aug. 27, 2010
(86) PCT No.: PCT/JP2010/005296

§ 371 Date: Dec. 11, 2012

(30) Foreign Application Priority Data
Jun. 28, 2010 (JP) 2010-145856

(51) Int. Cl. H04N 5/225

(52) U.S. Cl. CPC H04N 5/225
USPC 348/333.01

(57) ABSTRACT

An image capturing device can suppress unintended operation by the user. A digital camera has a CCD image sensor, a liquid crystal monitor, and electronic viewfinder, a touch panel, an eyepiece sensor, and a camera controller. The CCD image sensor captures an optical image of a subject and outputs it as image data. The electronic view finder is able to display a second image on the basis of image data. The touch panel is disposed over the surface of the liquid crystal monitor, and is able to undergo a first operation corresponding to a first image. The eyepiece sensor is able to detect proximity between the electronic viewfinder and an object.

### TECHNICAL FIELD

The present invention relates to a technique for preventing accidental user operation in an image capturing device such as a digital camera.

### BACKGROUND ART

A digital camera is a known example of an image capturing device that acquires an image of a subject. Some digital cameras that comprise a viewfinder and a liquid crystal monitor as display sections for displaying images and so forth also comprise proximity detection means such as an eye sensor near the viewfinder. This proximity detection means is used to control the digital camera. More specifically, if the proximity detection means detects that the user has put his eye up to the viewfinder, then the viewfinder is selected as the display section that displays the image. If the proximity detection means has not detected that the user has put his eye up to the viewfinder, the liquid crystal monitor is selected as the display section that displays the image.

A digital camera such as this has been disclosed which comprises a touch panel on a liquid crystal monitor (see Patent Literature 1, for example). The digital camera discussed in Patent Literature 1 has a rear face display, a touch panel, a registration means, a setting means, and a control means. According to Patent Literature 1, the touch panel is provided to a liquid crystal monitor serving as a rear face display, and can undergo touch panel operation. The registration means is used to register information about an eye that looks into an optical viewfinder. The setting means is used to set an inputtable region of the touch panel in which input by contact is possible, according to the registered eye information. Since the control means performs control, an operation corresponding to contact in the inputtable region is executed, while an operation corresponding to contact in a region of the touch panel other than the inputtable region is not executed. For instance, with the digital camera discussed in Patent Literature 1, it is conceivable that part of the face of the user looking into the optical viewfinder will touch a region of the touch panel other than the inputtable region. If this happens, this contact is not accepted as a valid operation, and operation corresponding to contact is not performed.

Patent Literature 1 also discloses that display on the rear face display is switched according to the detection result of the proximity detection means, and that touch panel is activated regardless of whether or not the rear face display is in a display state.

### CITATION LIST

### Patent Literature

Patent Literature 1: Japanese Laid-Open Patent Application 2009-260681

### SUMMARY

### Technical Problem

Thus, there are situations in which the display section that displays images is automatically switched on the basis of information obtained from the proximity detection means (hereinafter also referred to as automatic display switching).

Meanwhile, there are also situations in which automatic display switching is not performed by the proximity detection means in a digital camera. For example, with a digital camera, the setting is sometimes such that the display section is selected by having the user operate a display switching button or the like (hereinafter also referred to as manual display switching).

With a digital camera capable of touch panel operation, there will be times when the user selects the viewfinder as the display section, at which point touch panel operation corresponding to viewfinder display is activated. In this case, the user can operate the touch panel without looking at the display on the viewfinder. For example, if the rear face display is not in a display state, the user may not notice that the touch panel is activated, and may inadvertently touch the surface of the touch panel. As a result, there is the risk that the user of a digital camera will execute an unintended operation. That is, the operation may be performed by mistake.

It is an object of the technique disclosed herein to provide an image capturing device with which it is less likely that an operation unintended by the user will be carried out.

### Solution to Problem

The image capturing device disclosed herein comprises an imaging section, a first display section, a second display section, a touch panel, a proximity detector, and a controller. The imaging section captures an optical image of a subject and outputs it as image data. The first display section can display a first image based on image data. The second display section can display a second image based on image data. The touch panel is disposed over the surface of the second display section and can undergo a first operation corresponding to the first image. The proximity detector can detect proximity between the first display section and an object. The controller activates the first operation when the proximity detector has detected proximity between the first display section and an object, and deactivates the first operation when the proximity detector has not detected proximity between the first display section and an object, if the touch panel has undergone the first operation.

The term “image capturing device” here is a concept that encompasses not only an image capturing device capable of imaging by itself, but also a camera body. For example, “image capturing device” encompasses the camera body of an interchangeable lens type of camera to which an interchangeable lens unit can be mounted.

Also, the phrase “a first operation is activated” means that processing corresponding to a first operation is executed in the image capturing device. “A first operation is inactivated” means that the first operation will have substantially no effect on processing in the image capturing device.

The phrase “the touch panel undergoes a first operation” means that processing corresponding to a first operation is quickly executed in the image capturing device when the first operation is activated.

With this image capturing device, a condition for activation of the first operation is that there be proximity between the first display section and an object. Therefore, the first operation is activated when the user moves his eye close to the first display section. On the other hand, the first operation is inactivated when the user moves his eye away from the first display section. As a result, it is less likely that an operation not intended by the user will be carried out.

### ADVANTAGEOUS EFFECTS

With the technology disclosed herein, an image capturing device can be provided with which it is less likely that an operation unintended by the user will be carried out.

### BRIEF DESCRIPTION OF DRAWINGS

FIG. 1 is a rear view of a digital camera 1 pertaining to a first embodiment, as seen from the user side;

FIG. 2 is a block diagram of the main circuit configuration of the digital camera 1 pertaining to the first embodiment;

FIG. 3 is a flowchart of the operation of the digital camera 1 pertaining to the first embodiment; and

FIG. 4 is a flowchart of the operation of the digital camera 1 pertaining to the first embodiment.

### DESCRIPTION OF EMBODIMENTS

### First Embodiment

### Simplified Configuration of Digital Camera

A digital camera 1 (an example of an image capturing device) pertaining to a first embodiment will be described. The digital camera 1 has a camera body 100 and an interchangeable lens unit 200. In this first embodiment, the image capturing device is a digital camera having an interchangeable lens type of minor lens structure, and is a camera system having the camera body 100 and the interchangeable lens unit 200 that can be mounted to the camera body 100. The camera body 100 has the functions of both capturing still pictures and capturing moving pictures.

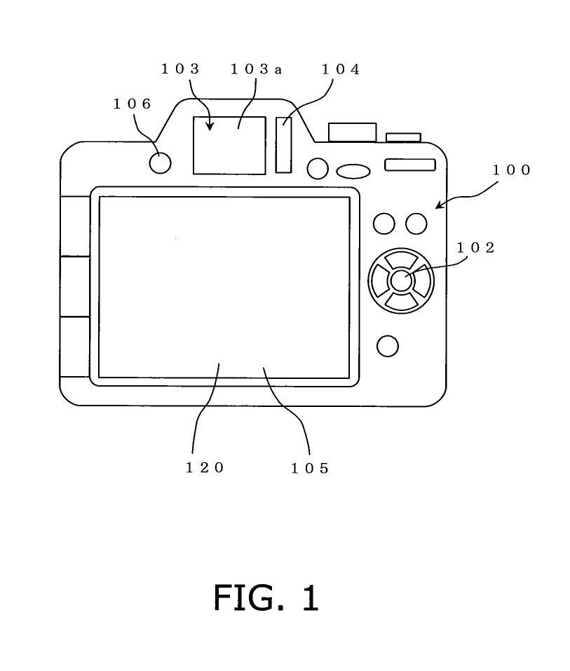

FIG. 1 is a rear view of the camera body 100, as seen from the user side. The “user side” here means the opposite side from the subject. A liquid crystal monitor 120 (an example of a second display section) is installed in the camera body 100 as a rear face display that displays images acquired by a CCD (charge coupled device) image sensor 110 (discussed below), a setting menu screen, or the like.

A touch panel 105 used for the liquid crystal monitor is provided to the front face of the liquid crystal monitor 120. A preprogrammed setting menu screen, for example, is displayed on the liquid crystal monitor 120. The display of the liquid crystal monitor 120 is transmitted through the touch panel 105. The user can see the setting menu screen through the touch panel 105. The user can select the category for the setting menu screen on the touch panel 105 by touching it. This allows the user to select and set various functions on the touch panel 105 by touch operation. The user can set, for example, the shutter speed, the aperture, the exposure correction, the sensitivity setting, the white balance, and other such settings by using the touch panel 105.

Aside from the liquid crystal monitor 120, the camera body 100 comprises an electronic viewfinder 103 (an example of a first display section) as a display that displays images acquired by the CCD image sensor 110, and so forth. The electronic viewfinder will sometimes be abbreviated as EVF below.

An eye sensor 104 is disposed as a proximity detector near the electronic viewfinder 103. When the user moves closer to the electronic viewfinder 103 to look into it, the eye sensor 104 senses the proximity of the user. When the proximity of the user is detected, the display is switched from the liquid crystal monitor 120 to the electronic viewfinder 103 according to the setting. The eye sensor 104 can be a reflective infrared sensor, for example. If the distance between the user's face and the electronic viewfinder 103 falls within a specific range, the eye sensor 104 outputs a proximity detection signal (hereinafter also referred to as a detection signal) to a camera controller 140 (discussed below). When the automatic display switching function is activated, the camera controller 140 stops the display on the liquid crystal monitor 120 and changes the display to the electronic viewfinder 103 if a detection signal has been received from the eye sensor 104.

It is also possible to activate the operation of the touch panel 105 when the display is on the electronic viewfinder 103. Thus, the digital camera 1 can receive through the touch panel 105 an operation corresponding to the image displayed on the electronic viewfinder 103. This function will hereinafter be called the EVF touch function. A state in which the EVF touch function is activated is a state in which EVF operating mode (discussed below) has been selected and a first operation (discussed below) is activated.

Consequently, touch operation of the setting menu screen shown on the electronic viewfinder 103, manipulation of operation-use characters displayed superimposed on the image, and so forth can be performed on the touch panel 105.

An “operation-use character” is an icon for carrying out some operation on the digital camera 1. For instance, with a quick menu, an operation-use character expressing the quick menu is displayed. The user confirms his intentions on the coordinates of the touch panel corresponding to the display position (coordinates) of this character. The displayed screen changes to a preprogrammed setting screen (quick menu display) for performing strobe adjustment and so forth, corresponding to the confirmation of the user's intentions.

Here, the “confirmation of the user's intentions” serves to convey the user's command to the digital camera 1, and is an intuitive operation by the user. For example, confirmation of the user's intentions includes double clicking with the mouse of a personal computer, to use a common example. In this embodiment, confirmation of the user's intentions includes tapping and dragging. Tapping involves lightly touching the surface of the touch panel 105. The user can point at an icon by tapping. Dragging involves sliding over the surface of the touch panel 105. The user can perform touch operations on the touch panel 105 by tapping or dragging.

With the digital camera 1, either the liquid crystal monitor 120 or the electronic viewfinder 103 can be selected as the display section on which an image is displayed. That is, the image can be displayed on the liquid crystal monitor 120, and the display on the electronic viewfinder 103 can be stopped. It is also possible to display the image on the electronic viewfinder 103 and stop the display on the liquid crystal monitor 120. This switching of the display section is carried out either automatically or intentionally.

More specifically, the digital camera 1 has an automatic display switching function and a manual display switching function. When the automatic display switching function is activated, the display on the liquid crystal monitor 120 and the display on the electronic viewfinder 103 are switched according to the detection signal of the eye sensor 104. When the manual display switching function is activated, the user switches the display section with a display switching button 106. In other word, when the automatic display switching function is deactivated, the manual display switching function is activated.

The user can select the automatic display switching function or the manual display switching function via the setting menu screen. For example, if the automatic display switching function is activated, the user can deactivate the automatic display switching function and activate the manual display switching function by selecting the manual display switching function from the setting menu screen. A mode in which images are simultaneously displayed on both the liquid crystal monitor 120 and the electronic viewfinder 103 may also be provided.

As shown in FIG. 1, a menu button 102 is disposed on the rear face of the camera body 100. The menu button 102 is pressed by the user. The menu button 102 is connected to the camera controller 140. The user can call up a setting menu screen by pressing the menu button 102. That is, the pressing of the menu button 102 calls up the setting menu screen, and the setting menu screen is displayed on the liquid crystal monitor 120 or the electronic viewfinder 103. The user can also display the setting menu screen by touching the touch panel 105.

The digital camera 1 has the display switching button 106 (an example of a switching operation receiver, and an example of a button switch). As shown in FIG. 1, the display switching button 106 is disposed on the rear face of the camera body 100. The display switching button 106 is pressed by the user. The display switching button 106 is connected to the camera controller 140. When the user has intentionally deactivated the automatic display switching function, and presses the display switching button 106, the display section on which the image is displayed is switched. That is, every time the user presses the display switching button 106 when the manual display switching function is activated, the display is switched back and forth between the liquid crystal monitor 120 and the electronic viewfinder 103.

Thus, with the digital camera 1, if the manual display switching function has been activated, where the image is displayed can be fixed at the electronic viewfinder 103 by pressing the display switching button 106. Furthermore, the system can be left in a state in which the EVF touch function is activated (more precisely, a state in which the EVF operating mode (discussed below) has been actuated). At this point, the camera controller 140 looks for a detection signal from the eye sensor 104, and automatically deactivates the operation of the touch panel 105 when the user is not looking into the electronic viewfinder 103. As a result, accidental operation and actuation are prevented.

The liquid crystal monitor 120 is a movable liquid crystal monitor. In this embodiment, the liquid crystal monitor 120 is a vari-angle monitor. That is, the liquid crystal monitor 120 can rotate around two different axes with respect to the main part of the camera body 100. Also, the display direction can be changed between vertical (portrait) and horizontal (landscape) according to the orientation of the liquid crystal monitor 120, and can also be inverted upside-down. The relation between the liquid crystal monitor 120 and touch panel operation here also changes according to the change in the display direction.

### Configuration of Camera Body

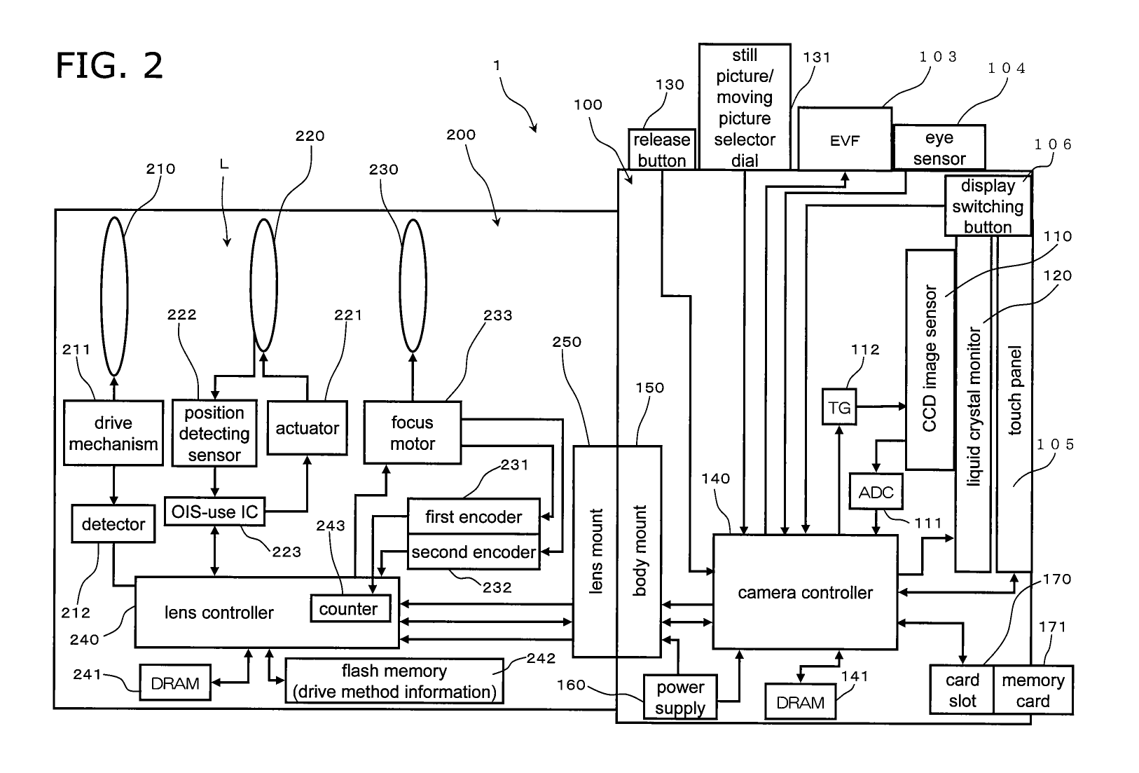

FIG. 2 is a simplified block diagram of the configuration of the digital camera 1 that captures subject images pertaining to the first embodiment. As discussed above, the digital camera 1 has the camera body 100 and the interchangeable lens unit 200 that can be mounted to the camera body 100.

The camera body 100 (an example of an image capturing device) mainly comprises the CCD image sensor 110, the liquid crystal monitor 120, the electronic viewfinder 103, the eye sensor 104, the touch panel 105, the display switching button 106, the camera controller 140, a body mount 150, a power supply 160, and a card slot 170.

The camera controller 140 (an example of a controller) controls the entire camera system, including the CCD image sensor 110, etc., under instructions inputted through a release button 130 or another such interface member. The camera controller 140 is a unit for executing computation, control, and other such processing. The camera controller 140 is an MPU (micro processing unit), for example.

The camera controller 140 sends a vertical synchronization signal to a timing generator 112. In parallel with this, the camera controller 140 produces an exposure synchronization signal on the basis of the vertical synchronization signal. The camera controller 140 repeatedly and periodically sends the exposure synchronization signal thus produced to a lens controller 240 via the body mount 150 and a lens mount 250. The camera controller 140 uses a DRAM 141 as a working memory during control operation or image processing operation.

The camera controller 140 controls the entire camera body 100 and performs imaging operations according to the imaging mode set by the user. Imaging modes include a moving picture capture mode and a still picture capture mode. The user operates a still picture/moving picture selector dial 131 to select the moving picture capture mode or the still picture capture mode. The camera controller 140 detects the status of the still picture/moving picture selector dial 131, and the imaging mode of the camera controller 140 is set to either moving picture capture mode or still picture capture mode depending on the detection result.

The CCD image sensor 110 (an example of an imaging section) captures an optical image of a subject (hereinafter also referred to as a subject image) incident through the interchangeable lens unit 200, and produces image data. The produced image data is digitized by an A/D converter 111. The image data digitized by the A/D converter 111 is subjected to various image processing by the camera controller 140. This “various image processing” includes gamma correction processing, white balance correction processing, scratch correction processing, YC conversion processing, electronic zoom processing, JPEG (Joint Photographic Experts Group) compression processing, and so forth.

The camera controller 140 produces display-use image data on the basis of the image data outputted from the CCD image sensor 110. A second image is displayed on the liquid crystal monitor 120 on the basis of the display-use image data. A first image is displayed on the electronic viewfinder 103, also on the basis of the display-use image data. The display of the second image on the liquid crystal monitor 120 and the display of the first image on the electronic viewfinder 103 are controlled by the camera controller 140. The camera controller 140 also performs what is known as on-screen display (OSD), in which display-use image data and characters or the like are displayed superimposed.

The timing at which the CCD image sensor 110 operates is controlled by the timing generator 112. Examples of the operation of the CCD image sensor 110 include the capture of a still picture, the capture of a moving picture, and the capture of a through-image. The user operates the still picture/moving picture selector dial 131 to switch between the capture of still pictures and the capture of moving pictures. A through-image is an image that is not recorded to a memory card 171 or other such recording device after its capture. A through-image is a moving picture mainly and is displayed on the liquid crystal monitor 120. A through-image is used to decide on the composition of a still picture.

The CCD image sensor 110 is an example of an imaging element that converts a subject image into image data. The imaging element (an example of an imaging section) is an electronic part that produces image data representing an image, and the concept of an imaging element encompasses a CMOS image sensor or other such opto-electrical conversion element, in addition to the CCD image sensor 110.

The liquid crystal monitor 120 is able to display a second image based on the display-use image data that underwent image processing by the camera controller 140. The liquid crystal monitor 120 can selectively display both moving pictures and still pictures. That is, the second image is either a moving picture or a still picture.

The liquid crystal monitor 120 has a liquid crystal panel (not shown) and a backlight (not shown). The liquid crystal panel is driven by a driver (not shown). The driver drives the liquid crystal panel to correspond to the second image. The backlight illuminates the rear face of the liquid crystal panel. The light emitted by the backlight goes through the liquid crystal panel. When the backlight is lit, the user can see the second image.

In this embodiment, when the display on the liquid crystal monitor 120 has been stopped, the supply of electrical power to the liquid crystal panel and the backlight is also stopped. To stop the display on the liquid crystal monitor 120, the supply of electrical power to the backlight may be stopped and the backlight turned off. If the backlight has been turned off, then even if the liquid crystal panel is driven by the driver, the display on the liquid crystal monitor 120 can be said to be stopped. If the backlight has been turned off, this helps prevent the light from being too bright for the user when the user moves his eye up to the electronic viewfinder 103 in EVF operating mode.

The electronic viewfinder 103 is similar to the liquid crystal monitor 120 in that it can display a first image based on the display-use image data that underwent image processing by the camera controller 140, within the viewfinder structure. The first image is either a moving picture or a still picture. In this embodiment, the electronic viewfinder 103 is disposed above the liquid crystal monitor 120. The first image may be the same as the second image, or may be different.

The electronic viewfinder 103 has a display device (not shown), a viewfinder optical system (not shown), and an eyepiece 103a. The display device is a small liquid crystal panel, for example, and displays a first image. The viewfinder optical system enlarges the first image displayed on the display device. The eyepiece 103a is a window the user looks into to see the first image. In this embodiment, the display device and the viewfinder optical system are included in the viewfinder structure. The entry of external scattered light into the viewfinder structure is suppressed. That is, within the viewfinder structure, external scattered light is substantially blocked off when the user's eye is up to the viewfinder. As a result, when the user looks into the electronic viewfinder 103, the user can see a clear image. When no power is being supplied to the electronic viewfinder 103, the display on the electronic viewfinder 103 is stopped.

The eye sensor 104 (an example of a proximity detector) detects proximity between the electronic viewfinder 103 and an object. The eye sensor 104 can also be said to detect the proximity of an object to the electronic viewfinder 103. The eye sensor 104 is an infrared type of proximity detecting sensor, for example, and is provided closer to the electronic viewfinder 103. Here, the “object” is something that has a size and material that can be detected by the eye sensor 104. Examples of objects include the user's eye, face, or head.

The eye sensor 104 has an infrared light emitting element (not shown) and an infrared light receiving element (not shown). The infrared light emitting element emits infrared rays. The infrared light receiving element receives and detects infrared rays. When the electronic viewfinder 103 and the object are in close proximity, infrared rays emitted by the infrared light emitting element are reflected by the object (also called a reflecting object), and are detected by the infrared light receiving element. When the infrared light receiving element detects infrared rays, the eye sensor 104 outputs a detection signal. More precisely, the eye sensor 104 outputs a detection signal when a reflecting object has moved to within a specific distance from the electronic viewfinder 103. More specifically, the detection signal is expressed by a signal change between high (H) and low (L).

The camera controller 140 receives the detection signal outputted from the eye sensor 104. The camera controller 140 controls the digital camera 1 on the basis of the detection signal outputted by the eye sensor 104. For example, when the automatic display switching function is activated, the camera controller 140 switches the display section on which the image is displayed on the basis of the inputted detection signal. More specifically, when the eye sensor 104 detects user proximity, the camera controller 140 stops the display on the liquid crystal monitor 120, and starts the display on the electronic viewfinder 103.

A decision as to whether or not there is proximity between the electronic viewfinder 103 and the user is made on the basis of the detection signal. For example, if the output signal from the eye sensor 104 has changed from H to L, the camera controller 140 decides that proximity of the object has been detected. If the output signal from the eye sensor 104 is maintained in the L state, the camera controller 140 decides that proximity of the object is being maintained. On the other hand, if the output signal from the eye sensor 104 changes from L to H, the camera controller 140 decides that proximity of the object has not been detected. If the output signal from the eye sensor 104 is maintained in the H state, the camera controller 140 decides that a state in which the object is not nearby is being maintained.

The touch panel 105 is installed on the front face of the display screen of the liquid crystal monitor 120. The touch panel 105 can also be said to be disposed over the surface of the liquid crystal monitor 120. The touch panel 105 has a touch sensor. This touch sensor detects contact. The touch sensor also outputs a signal expressing the touch location where there was contact. The touch sensor can be a resistance film type or an electrostatic capacitance type, for example. The touch panel 105 is under the control of the camera controller 140.

The touch panel 105 undergoes various touch operations. The user can perform various touch operations by touching operation-use characters in an OSD or a video display.

An example of these various touch operations is when the user specifies the focus position by touch. The “focus position” is the part of the subject that is in focus. The user can specify a touch point as the focus position by touching part of the subject displayed as a through-image. The camera controller 140 instantly calculates the characteristics of the subject corresponding to the touch position. The camera controller 140 sets the focus position to the part of the subject that was touched (that is, the portion corresponding to the touch position) on the basis of the calculated characteristics.

There is a hierarchy to the operations performed with the touch panel 105. For example, a character (that is, icon) meaning menu opening is displayed on the OSD. When the user touches the character meaning menu opening, the camera controller 140 instantly opens the menu on the image. The user can select the desired category by touch operation from the opened menu.

The touch panel 105 is able to receive monitor touch operations corresponding to a second image (hereinafter also referred to as second operations). The touch panel 105 is also able to receive EVF touch operations corresponding to a first image (hereinafter also referred to as first operations). When the touch panel 105 has received a monitor touch operation, the touch panel 105 is operating in monitor operating mode. On the other hand, when the touch panel 105 has received an EVF touch operation, the touch panel 105 is operating in EVF operating mode. The operating modes thus include EVF touch mode and monitor operating mode.

In EVF operating mode (an example of a first mode), the user operates the touch panel 105 on the basis of the first image displayed on the electronic viewfinder 103. In EVF operating mode, a position on the first image is associated with a position on the touch panel 105. Therefore, when the user touches the touch panel 105 in EVF operating mode, for example, an icon within the first image displayed on the electronic viewfinder 103 is selected. Thus, in EVF operating mode, the touch panel 105 undergoes a first operation. That is, if the first operation is inputted to the touch panel 105 when the first operation is activated in EVF operating mode, processing corresponding to the first operation will be executed rapidly.

In monitor operating mode (an example of a second mode), the user operates the touch panel 105 on the basis of the second image displayed on the liquid crystal monitor 120. In monitor operating mode, a position on the second image is associated with a position on the touch panel 105. Therefore, in monitor operating mode, when the user touches the touch panel 105, for example, an icon in the second image displayed on the liquid crystal monitor 120 is selected. Thus, in monitor operating mode, the touch panel 105 undergoes a second operation. That is, if a second operation is inputted to the touch panel 105 when the second operation is activated in monitor operating mode, processing corresponding to the second operation will be executed rapidly.

In this embodiment, if the liquid crystal monitor 120 is selected as the display section to display the image, the digital camera 1 switches to monitor operating mode. If the electronic viewfinder 103 is selected as the display section to display the image, the digital camera 1 switches to EVF operating mode. The switching of the operating mode is controlled by the camera controller 140.

When the automatic display switching function is activated, the monitor operating mode or EVF operating mode is selected on the basis of the detection result from the eye sensor 104. That is, the EVF operating mode is selected by the camera controller 140 if the eye sensor 104 has detected that the user has put his eye up to the viewfinder. The monitor operating mode is selected by the camera controller 140 if the eye sensor 104 has not detected that the user has put his eye up to the viewfinder.

On the other hand, if the manual display switching function is activated, either the monitor operating mode or the EVF operating mode is selected on the basis of the input to the display switching button 106.

As discussed above, the display switching button 106 is connected to the camera controller 140. The camera controller 140 operates on the basis of the input to the display switching button 106 when the manual display switching function is activated (that is, when the automatic display switching function is deactivated). More specifically, the camera controller 140 switches the activated display section every time the display switching button 106 is pressed. More precisely, the camera controller 140 stops the display on the liquid crystal monitor 120 and starts the display on the electronic viewfinder 103 when the display switching button 106 is pressed. Or, the camera controller 140 stops the display on the electronic viewfinder 103 and starts the display on the liquid crystal monitor 120 when the display switching button 106 is pressed.

The camera controller 140 starts the display on the liquid crystal monitor 120 while actuating the monitor operating mode. The camera controller 140 also starts the display on the electronic viewfinder 103 while actuating the EVF operating mode.

More specifically, the camera controller 140 switches between monitor operating mode and EVF operating mode on the basis of the input to the display switching button 106. More specifically, when the manual display switching function is activated, the camera controller 140 detects whether or not the display switching button 106 has been pressed. If the display switching button 106 has been pressed, the camera controller 140 switches the operating mode of the touch panel 105. More precisely, when the display switching button 106 is pressed in monitor operating mode, the camera controller 140 changes the operating mode to EVF operating mode. On the other hand, when the display switching button 106 is pressed in EVF operating mode, the camera controller 140 changes the operating mode to monitor operating mode. Therefore, the camera controller 140 can be said to control the touch panel 105 so that it operates in either monitor operating mode or EVF operating mode.

As discussed above, the user can stop automatic display switching by the eye sensor 104 by selection on a setting menu displayed on the liquid crystal monitor 120 or the electronic viewfinder 103, on the basis of the user's intention and operation. Even if the automatic display switching function has been stopped, switching of the display and operating modes can still be carried out manually.

The card slot 170 allows a memory card 171 to be mounted. The card slot 170 controls the memory card 171 on the basis of control from the camera controller 140. The memory card 171 can store image data produced by image processing by the camera controller 140. for example, the memory card 171 can stored JPEG image files. The memory card 171 can also output image files or image data stored internally. An image file or image data outputted from the memory card 171 is subjected to image processing by the camera controller 140. For example, the camera controller 140 produces display-use image data by expanding an image file or image data acquired from the memory card 171.

The power supply 160 supplies electrical power for use by the camera system. The power supply 160 may be a dry cell or a rechargeable cell, for example. The power supply 160 may also be a unit that supplies the camera system with power supplied from the outside through a power cord.

The body mount 150 can be mechanically and electrically connected to the lens mount 250 of the interchangeable lens unit 200. The body mount 150 can send and receive data to and from the interchangeable lens 200 through the lens mount 250. The body mount 150 sends the lens controller 240, via the lens mount 250, an exposure synchronization signal received from the camera controller 140. Also, other control signals received from the camera controller 140 are sent through the lens mount 250 to the lens controller 240. The body mount 150 also sends the camera controller 140 signals received from the lens controller 240 via the lens mount 250. For example, the body mount 150 receives drive method information related to the drive method for a focus lens 230 from the lens controller 240, via the lens mount 250. The body mount 150 sends the received drive method information to the camera controller 140. The drive method information is stored in a flash memory 242 of the interchangeable lens unit 200. The body mount 150 also supplies power received from the power supply 160, to the entire interchangeable lens unit 200 via the lens mount 250.

### Configuration of Interchangeable Lens Unit

The interchangeable lens unit 200 mainly comprises an optical system L, the lens controller 240, and the lens mount 250. The optical system L of the interchangeable lens unit 200 includes a zoom lens 210, an OIS lens 220, and the focus lens 230.

The zoom lens 210 is used to change the zoom ratio of a subject image formed by the optical system L of the interchangeable lens unit 200. The zoom lens 210 is made up of one or more lenses.

A drive mechanism 211 includes a zoom ring, etc., that can be operated by the user. The zoom ring is disposed on the outer peripheral part of the interchangeable lens unit 200, for example. The drive mechanism 211 transmits the user's input to the zoom lens 210. More specifically, the drive mechanism 211 moves the zoom lens 210 along the optical axis direction of the optical system on the basis of what the user has inputted through the zoom ring, etc.

A detector 212 detects the amount of drive of the zoom lens 210 via the drive mechanism 211. The lens controller 240 ascertains the position of the zoom lens 210 by acquiring the detection result from the detector 212. Thus, the lens controller 240 can acquire the zoom ratio of the optical system L.

The OIS lens 220 is used to correct blurring of a subject image formed by the optical system L of the interchangeable lens unit 200. The OIS lens 220 reduces blurring of the subject image on the CCD image sensor 110 by moving in the direction that cancels out shake of the digital camera 1. The OIS lens 220 is made up of one or more lenses.

An actuator 221 is controlled by an OIS-use IC 223, and drives the OIS lens 220 within a plane perpendicular to the optical axis of the optical system L. The actuator 221 can be a magnet and a flat coil, for example.

A position detecting sensor 222 is used to detect the position of the OIS lens 220 within a plane perpendicular to the optical axis of the optical system L. The position detecting sensor 222 can be a magnet and a Hall element, for example. A gyro sensor or other such shake detector (not shown) detects shaking of the digital camera 1.

The OIS-use IC 223 controls the actuator 221 on the basis of the detection result of the shake detector and the detection result of the position detecting sensor 222. The OIS-use IC 223 obtains the detection result of the shake detector from the lens controller 240. Also, the OIS-use IC 223 sends the lens controller 240 a signal indicating the state of optical image blur correction processing.

A first shake correcting unit includes the actuator 221, the position detecting sensor 222, the OIS-use IC 223, and the shake detector, and as discussed above is used to detect shaking of the digital camera 1 and to correct image blurring caused by shaking of the digital camera 1. The lens controller 240 also controls the correction operation performed by the first shake correcting unit.

The focus lens 230 is used to change the focal state of a subject image formed on the CCD image sensor 110. The focus lens 230 is made up of one or more lenses.

A focus motor 233 drives the focus lens 230 so that it moves forward and backward along the optical axis of the optical system L, under control by the lens controller 240. This allows the focal state of a subject image formed on the CCD image sensor 110 to be changed. A DC motor can be used as the focus motor 233 in this embodiment. The focus motor 233 is not limited to being a DC motor, however, and may instead be a stepping motor, a servo motor, an ultrasonic motor, or the like.

A first encoder 231 and a second encoder 232 are used to produce signals indicating the drive state of the focus lens 230. The first encoder 231 and the second encoder 232 can be a rotor and a photocoupler attached to the rotary shaft of the focus motor 233, for example. The rotor here is a disk with holes made at regular intervals. The photocoupler emits detection light from one side of the rotor, and receives light from the other side. Therefore, as the rotor rotates, the on/off state of the photocoupler is switched back and forth.

The lens controller 240 has a counter 243. The counter 243 counts how many times the on/off state of the photocoupler is switched.

The signal obtained from the first encoder 231 and the signal obtained from the second encoder 232 are offset in phase to one another. Therefore, when the state of the first encoder 231 is switched from off to on, the movement direction of the focus lens 230 can be determined by checking the signal obtained from the second encoder 232. More specifically, possible states for the second encoder 232 when the state of the first encoder 231 is switched from off to on are an on state and an off state. If the state of the first encoder 231 is switched from off to on when the state of the second encoder 232 is on, the counter 243 determines this to be positive rotation and increments the count by “+1.” On the other hand, if the state of the first encoder 231 is switched from off to on when the state of the second encoder 232 is off, the counter 243 determines this to be reverse rotation and lowers the count by “−1.” The lens controller 240 can thus ascertain the amount of movement of the focus lens 230 by totaling the count.

The lens controller 240 controls the entire interchangeable lens unit 200, including the OIS-use IC 223, the focus motor 233, and so forth, on the basis of control signals from the camera controller 140. For example, the lens controller 240 controls the focus motor 233 on the basis of a control signal from the camera controller 140. Under control by the lens controller 240, the focus motor 233 moves the focus lens 230 backward or forward in a specific drive direction along the optical axis of the optical system L. The lens controller 240 receives signals from the detector 212, the OIS-use IC 223, the first encoder 231, the second encoder 232, and so forth, and sends these signals to the camera controller 140. The lens controller 240 exchanges signals with the camera controller 140 via the lens mount 250 and the body mount 150. The lens controller 240 uses a DRAM 241 as a working memory.

Correspondence to this Embodiment

The CCD image sensor 110 is an example of an imaging section. The liquid crystal monitor 120 is an example of a second display section. The electronic viewfinder 103 is an example of a first display section. The eye sensor 104 is an example of a proximity detector. The camera controller 140 is an example of a controller.

### Operation of Digital Camera 1

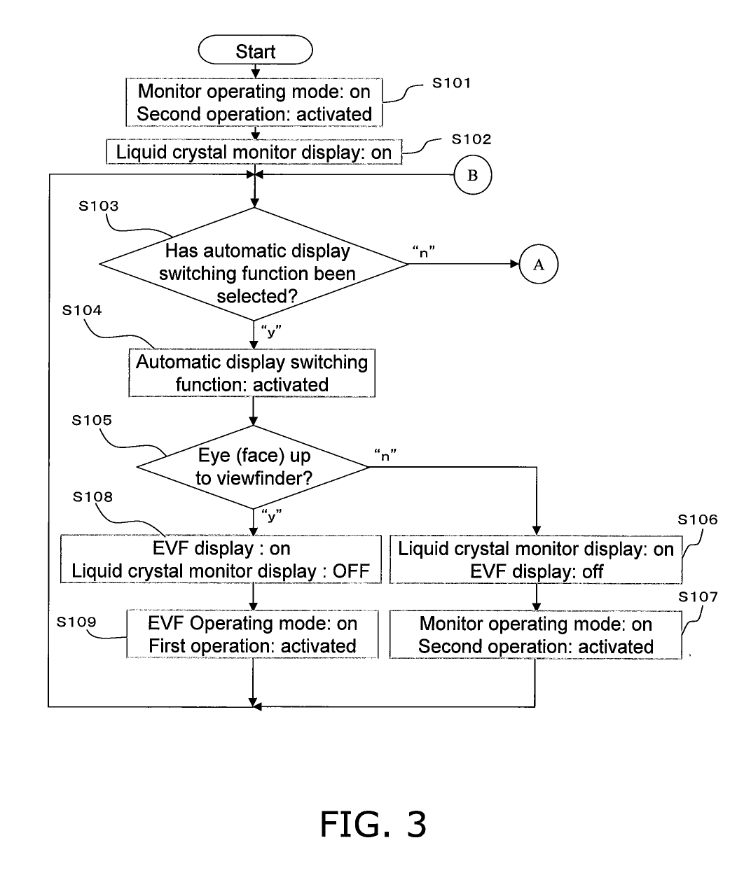

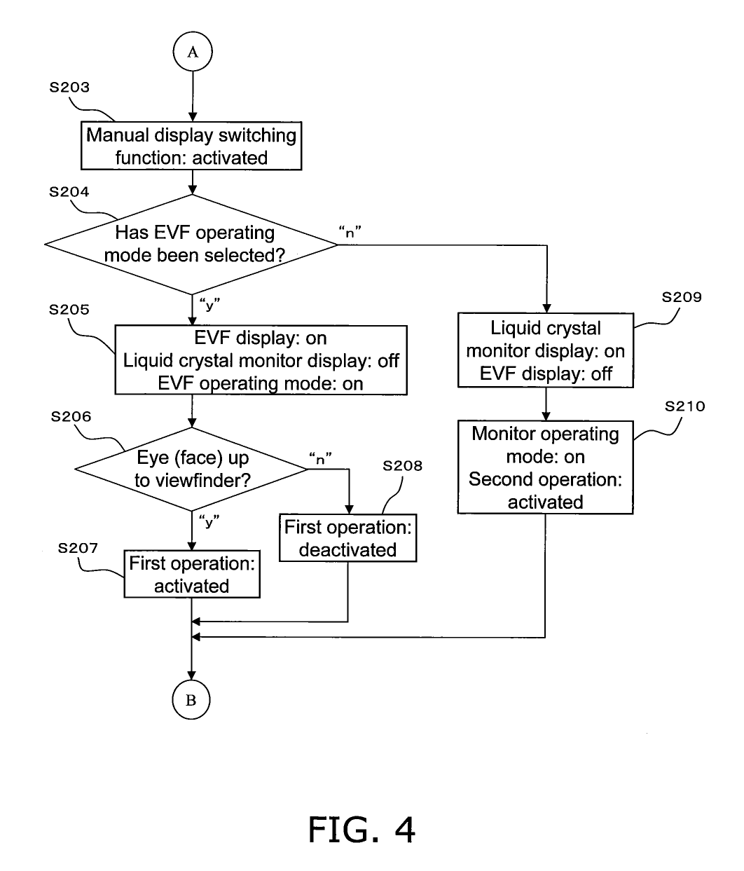

FIGS. 3 and 4 are flowcharts of processing for switching the screen display in the camera body 100.

Operation when Automatic Display Switching Function is Activated

FIG. 3 shows the standard operation when the automatic display switching function is activated. When the automatic display switching function is activated, processing for switching the screen display is executed according to the detection result of the eye sensor 104. In this embodiment, the camera controller 140 activates touch operation based on the display of the liquid crystal monitor 120 as soon as the power is turned on (step S101). That is, in step S101, the camera controller 140 activates the monitor operating mode. Furthermore, in step S101 the camera controller 140 activates the second operation. The first operation is deactivated at this point.

The camera controller 140 sets the liquid crystal monitor 120 to display captured images and so forth (step S102). More specifically, in step S102 the camera controller 140 displays the second image on the liquid crystal monitor 120. Thus, in step S102, the liquid crystal monitor 120 is in its on state.

The camera controller 140 determines whether or not the automatic display switching function has been selected (step S103). As discussed above, the user selects either the automatic display switching function or the manual display switching function. Information about whether the automatic display switching function or the manual display switching function has been selected is stored, for example, in the DRAM 141 or a nonvolatile memory (not shown). In step S103, the camera controller 140 can determine whether or not the automatic display switching function has been selected on the basis of this stored information.

If the automatic display switching function has been selected in step S103, the processing proceeds to step S104. If the manual display switching function has been selected in step S103, the processing proceeds to step S203 (FIG. 4).

If the automatic display switching function has been selected, the camera controller 140 activates the automatic display switching function (step S104).

When the camera controller 140 activates the automatic display switching function, the eye sensor 104 detects whether or not the user has brought his eye up to the electronic viewfinder 103 (step S105). If the camera controller 140 decides from the detection result of the eye sensor 104 that it has not been detected that the user has brought his eye up to the electronic viewfinder (that is, if the answer is “No” in step S105), the processing proceeds to step S106).

If it has not been detected that the user has brought his eye up to the electronic viewfinder, the camera controller 140 displays the second image, including a captured image, etc., on the liquid crystal monitor 120, and stops display on the electronic viewfinder 103 (step S106). That is, the electronic viewfinder 103 goes into the off state. When the electronic viewfinder 103 is in the off state, that off state is maintained. Thereafter, in the same manner, when a display section that is supposed to be switched on is already in the on state, the on state is maintained in processing for putting the liquid crystal monitor 120 or the electronic viewfinder 103 in the on state. Also, when a display section that is supposed to be switched off is already in the off state, the off state is maintained in processing for putting the liquid crystal monitor 120 or the electronic viewfinder 103 in the off state.

Furthermore, the camera controller 140 actuates the monitor operating mode (step S107). That is, in step S107, the monitor operating mode goes into the on state. In this embodiment, the entire region of the touch panel 105 undergoes the user's second operation. The “entire region of the touch panel 105” is the region of the touch panel 105 that overlaps the entire region of the second image displayed on the liquid crystal monitor 120. Thus, in monitor operating mode, the entire region of the touch panel 105 is set as the region in which user operations can be inputted (hereinafter also referred to as the inputtable region). Also, in step S107, the camera controller 140 puts the second operation in an activated state.

Once the processing in step S107 ends, the processing goes back to step S103. After this, the processing in step S103 and checking for whether the user has brought his eye up to the eye sensor 104 (step S105) are carried out at regular intervals (such as every 1/60 of a second) unless there is an interrupt operation, such as forced operation to another mode or an imaging operation. In a state in which the processing of steps S103 to S107 is being repeatedly executed, monitor touch operation (that is, the second operation) is activated. Therefore, the user can operate the digital camera 1 via the touch panel 105 on the basis of the second image displayed on the liquid crystal monitor 120.

On the other hand, if it is determined that the user has brought his eye up to the electronic viewfinder 103 (that is, if the answer is “Yes” in step S105), the display of captured images and so forth on the liquid crystal monitor 120 is stopped, and image display on the electronic viewfinder 103 is carried out (step S108). Thus, in step S108, the camera controller 140 stops the display of the second image on the liquid crystal monitor 120. That is, the camera controller 140 puts the liquid crystal monitor 120 in the off state. More specifically, the backlight of the liquid crystal monitor 120 is turned off. Furthermore, in step S108, the camera controller 140 starts the display of the first image on the electronic viewfinder 103. That is, the camera controller 140 puts the electronic viewfinder 103 in the on state.

When the user's eye is detected, the camera controller 140 actuates the EVF operating mode (step S109). In other words, in step S109 the camera controller 140 puts the EVF operating mode in the on state. In this embodiment, the entire region of the touch panel 105 undergoes the first operation of the user. The “entire region of the touch panel 105” is the region of the touch panel 105 that overlaps the display image on the liquid crystal monitor 120. Thus, in EVF operating mode, the entire region of the touch panel 105 is set as the inputtable region. Furthermore, in step S109 the camera controller 140 puts the first operation in an activated state.

Once the processing in step S109 ends, the processing goes back to step S103. After this, the processing in step S103 and checking for whether the user has brought his eye up to the eye sensor 104 (step S105) are carried out at regular intervals. In a state in which the processing of steps S103 to S109 is being repeatedly executed, the above-mentioned EVF touch function is activated. Therefore, the user can operate the digital camera 1 via the touch panel 105 on the basis of the first image displayed on the electronic viewfinder 103.

Thus, if the automatic display switching function is activated, an image is displayed on the liquid crystal monitor 120 when the user has not brought his eye up to the electronic viewfinder 103. Therefore, the user can confirm that the power to the digital camera 1 is on and the camera is operating, and that operation with the touch panel 105 (more precisely, the second operation) is activated.

### Operation When Manual Display Switching Function is Activated

FIG. 4 is a flowchart of the operation when the manual display switching function, in which the user manually switches the screen display, is activated.

As discussed above, in step S103 it is determined whether the automatic display switching function or the manual display switching function has been selected. If the manual display switching function has been selected (that is, when the answer is “n” in step S103), the camera controller 140 activates the manual display switching function (step S203).

The fact that the automatic display switching function has been deactivated, that is, that the manual display switching function has been activated, is stored temporarily in the DRAM 141, for example.

Once the manual display switching function is activated, the camera controller 140 determines whether or not EVF operating mode has been selected (step S204). In step S204, it is determined whether the monitor operating mode or the EVF operating mode has been selected as the operating mode.

More specifically, if the user presses the display switching button 106 while the liquid crystal monitor 120 is displaying, EVF operating mode is selected. If it is decided that the EVF operating mode has been selected in step S204, the processing proceeds to step S205. If it is decided that the monitor operating mode has been selected in step S204, the processing proceeds to step S209.

A flag is set, for example, to determine the selected operating mode. The value of the flag varies according to the selected operating mode. As an example, the value of the flag is “1” when the monitor operating mode has been selected as the operating mode, and the value of the flag is “0” when the EVF operating mode has been selected as the operating mode. The value of the flag is stored in the DRAM 141, for example.

In this embodiment, the value of the flag is changed when the user presses the display switching button 106. More specifically, when the display switching button 106 is pressed, an output signal is outputted to the camera controller 140. The camera controller 140 changes the value of the flag upon receiving the output signal from the display switching button 106. For example, when the display switching button 106 is pressed in order to switch the operating mode from monitor operating mode to EVF operating mode, the camera controller 140 changes the value of the flag from “1” to “0.”

In step S204, the camera controller 140 reads the value of the flag. The camera controller determines whether the monitor operating mode or the EVF operating mode has been selected, on the basis of the value of the flag.

The selected operating mode may also be stored in a nonvolatile memory (not shown) at the point when the user ends operation of the digital camera 1. If the manual display switching function is activated at start-up of the digital camera 1, the camera controller 140 can select the operating mode stored in the nonvolatile memory in step S204.

When EVF operating mode has been selected, the camera controller 140 commences the display of a first image on the electronic viewfinder 103, and stops display on the liquid crystal monitor 120 (step S205). Thus, when EVF operating mode has been selected, the camera controller 140 stops display on the liquid crystal monitor 120. Also, in step S205, the camera controller 140 actuates the EVF operating mode. That is, the camera controller 140 puts the EVF operating mode in the on state. In processing to put the EVF operating mode or the monitor operating mode in the on state, the on state is maintained if the operating mode that is supposed to be on is already on. Similarly, in processing to put the EVF operating mode or the monitor operating mode in the off state, the off state is maintained if the operating mode that is supposed to be off is already off.

When the EVF operating mode is actuated, the camera controller 140 determines whether or not it has been detected that the user has brought his eye up to the viewfinder (step S206). The camera controller 140 monitors the eye sensor 104 at regular periods, and determines whether or not the eye has been detected.

The camera controller 140 activates the first operation when it has been determined that the user has brought his eye up to the electronic viewfinder 103 on the basis of the detection signal from the eye sensor 104 (that is, when the answer is “Yes” in step S206) (step S207). Once the processing of step S207 ends, the processing returns to step S103.

In a state in which the processing of steps S103 to S207 is being repeatedly executed, the EVF touch function is activated. Therefore, the user can operate the digital camera 1 via the touch panel 105 on the basis of the first image displayed on the electronic viewfinder 103.

The camera controller 140 puts the first operation in a deactivated state if no detection signal has been outputted from the eye sensor 104 and it is determined that the user has not brought his eye up to the electronic viewfinder 103 (that is, when the answer is “n” in step S206) (step S208). Since the operating mode is the EVF operating mode at this point, the touch panel 105 does not undergo a second operation. Therefore, the second operation is in a deactivated state. Once the processing in step S208 ends, the processing returns to step S103.

In a state in which the processing of steps S103 to S208 is being repeatedly executed, the user cannot use the EVF touch function. Also, since the EVF operating mode has been selected, the second operation is deactivated. Therefore, in a state in which the processing of steps S103 to S208 is being repeatedly executed, the user cannot operate the digital camera 1 via the touch panel 105.

Here, deactivating the touch operation (more specifically, the first operation or second operation) means that an operation performed on the touch panel 105 will have substantially no effect on the processing in the digital camera 1. Therefore, deactivating touch operation is a concept that includes stopping the supply of power to the touch panel 105, not outputting a signal corresponding to operation of the touch panel 105 even when the touch panel 105 is operated, and having the camera controller 140 ignore a signal corresponding to operation of the touch panel 105 even if such a signal is outputted.

Let us assume a state in which there is no display on the liquid crystal monitor 120, and operation of the touch panel 105 (more precisely, the first operation) has been activated. In this state, it will be difficult for the user to recognize that the power is on and the digital camera 1 is operating, and that operation with the touch panel 105 has been activated. In view of this, with the digital camera 1, touch operation (more specifically, the first operation) is deactivated when the user is not looking into the electronic viewfinder 103. As a result, erroneous operation of the touch panel 105 can be prevented when the user has not brought his eye up to the electronic viewfinder 103.

The phrase “the touch panel 105 has undergone a touch operation (more specifically, a first operation or a second operation)” means a state in which processing corresponding to touch operation is quickly executed when touch operation is activated. Therefore, even if the supply of power to the touch panel 105 has been stopped in step S208, for example, it can be said that the touch panel 105 has undergone a first operation. If the operating mode has been set to EVF operating mode, then power is immediately supplied to the touch panel 105 when the first operation is switched from deactivated to activated, and the touch panel 105 begins detecting touch operation. Thus, even if the supply of power to the touch panel 105 is stopped in step S208, for example, the touch panel 105 can be said to be operating in EVF operating mode.

In the flowchart of FIG. 4, when it is determined in step S204 that the monitor operating mode has been selected, the processing proceeds to step S209. The camera controller 140 starts or continues display on the liquid crystal monitor 120, and stops display on the electronic viewfinder 103 (step S209).

When the processing of step S209 ends, the camera controller 140 actuates the monitor operating mode (step S210). In step S210, the camera controller 140 activates the second operation.

When the processing of step S210 ends, the processing returns to step S103. In a state in which the processing of steps S103 to S210 is being executed repeatedly, monitor touch operation (that is, the second operation) is activated. Therefore, the user can operate the digital camera 1 via the touch panel 105 on the basis of the second image displayed on the liquid crystal monitor 120.

### Conclusion

The effects of the digital camera 1 pertaining to the first embodiment will be compiled below.

(1) With this digital camera 1, the touch panel 105 is able to undergo a first operation corresponding to a first image. The eye sensor 104 is able to detect proximity between the user and the electronic viewfinder 103. When the touch panel 105 has undergone a first operation, and the eye sensor 104 has detected proximity between the user and the electronic viewfinder 103, the camera controller 140 activates the first operation. When the touch panel 105 has undergone a first operation, but the eye sensor 104 has not detected proximity between the user and the electronic viewfinder 103, the camera controller 140 deactivates the first operation.

Thus, when the touch panel 105 has undergone a first operation, the first operation is activated on the condition that the user is close to the electronic viewfinder 103. Therefore, when the user brings his eye up to the electronic viewfinder 103, the first operation is activated. When the user moves his eye away from the electronic viewfinder 103, the first operation is deactivated. As a result, it is less likely that an operation that is not intended by the user will occur.

More specifically, the first operation is deactivated even if the user accidentally touches the touch panel 105 when the user has not brought his eye up to the electronic viewfinder 103. As a result, erroneously operation is less apt to happen.

The phrase “the first operation is activated” here means that processing corresponding to the first operation is executed in the digital camera 1. “The first operation is deactivated” means that the first operation will have substantially no effect on processing in the digital camera 1. Therefore, deactivating touch operation is a concept that includes stopping the supply of power to the touch panel 105, not outputting a signal corresponding to operation of the touch panel 105 even when the touch panel 105 is operated, and having the camera controller 140 ignore a signal corresponding to operation of the touch panel 105 even if such a signal is outputted.

Also, the phrase “the touch panel 105 has undergone a first operation” means a state in which processing corresponding to the first operation is executed rapidly in the digital camera 1 when the first operation is activated.

(2) With this digital camera 1, the touch panel 105 is able to undergo a second operation corresponding to a second image, so the user can select the method for operating the touch panel 105. Meanwhile, if the touch panel 105 has undergone a first operation, erroneous operation is less apt to occur. Therefore, the occurrence of erroneous operation can be reduced while a variety of operating methods are possible. Thus, the camera is more convenient for the user to use.

(3) With this digital camera 1, when the touch panel 105 is undergoing a first operation, display on the liquid crystal monitor 120 is stopped. This reduces power consumption.

Also, the brightness of the liquid crystal monitor 120 can be reduced when the user brings his eye up to the electronic viewfinder 103. As a result, when the user brings his eye up to the electronic viewfinder 103, the image will not seem too bright.

(4) With this digital camera 1, the camera controller 140 controls the touch panel 105 so as to operate in either monitor operating mode or EVF operating mode, so a single touch panel 105 can be operated in a plurality of modes. This allows the touch panel 105 to be utilized more effectively.

Also, the digital camera 1 has the display switching button 106 that can be pressed. The camera controller 140 switches between the monitor operating mode and the EVF operating mode on the basis of the pressing of the display switching button 106. Therefore, the user can switch the operating mode of the touch panel 105 by pressing the display switching button 106. Thus, the operating mode can be changed by the user to suit the situation, by a simple operation. This makes the camera more convenient for the user to use.

### Other Embodiments

Embodiments of the present invention are not limited to the embodiment given above, and various changes and alterations are possible without departing from the gist of the invention.

(A) In the above embodiment, a configuration was described involving switching the display between the electronic viewfinder 103 and the liquid crystal monitor 120. The electronic viewfinder 103 was used in the above embodiment, but an optical viewfinder may be used instead of the electronic viewfinder 103. A subject image exiting the lens unit is reflected by a reflecting mirror and guided to the optical viewfinder. The user can see the subject image through the optical viewfinder.

If an optical viewfinder is used, a liquid crystal panel capable of displaying superimposed subject images is disposed within the viewfinder, and on-screen display or the like is performed on this liquid crystal panel. If it is detected from the detection signal of the eye sensor 104 that the user has brought his eye up to the optical viewfinder, the camera controller 140 activates the operation performed on the touch panel 105. If the user operates the touch panel 105 while looking into the optical viewfinder, the content of the display on the liquid crystal panel inside the optical viewfinder changes according to the inputted operation. On the other hand, if no detection signal has been outputted from the eye sensor 104 and it is determined that the user has not brought his eye up to the optical viewfinder, the camera controller 140 deactivates the operation performed on the touch panel 105.

(B) In the above embodiment, display on the liquid crystal monitor 120 was stopped in EVF operating mode, but an image may be displayed on the liquid crystal monitor 120 in EVF operating mode. For example, an image showing that EVF operating mode has been selected may be displayed on the liquid crystal monitor 120 in EVF operating mode. The brightness of the liquid crystal monitor 120 can be set lower here. Reducing the brightness of the liquid crystal monitor 120 prevents the image from appearing too bright when the user brings his eye up to the electronic viewfinder 103.

(C) In the above embodiment, the liquid crystal monitor 120 was used as an example of a second display section, but the second display section may be something other than a liquid crystal monitor. The second display section may be any device that can display an image. Other examples of the second display section besides a liquid crystal monitor include an organic EL panel, an inorganic EL panel, and a plasma display panel.

In the above embodiment, a liquid crystal panel was used as the display device used for the electronic viewfinder 103, but the display device may be something other than a liquid crystal panel. The display device used for the electronic viewfinder 103 may be any device that can display an image. Examples of the display device used for the electronic viewfinder other than a liquid crystal monitor 103 include an organic EL panel, an inorganic EL panel, and a plasma display panel.

(D) The various processing in the above embodiment may be accomplished with hardware, or by software (including the concurrent use of an OS (operating system), middle ware, and a specific library). Furthermore, the various processing in the above embodiment may be accomplished with a combination of software and hardware. It should go without saying that when the various processing in the above embodiment is accomplished with hardware, the timing at which the various processing steps are carried out will need to be adjusted. In the above embodiment, details about the adjustment of the timing of the various signals that happens in the actual design of hardware were omitted for the sake of simplifying the description.

Also, the order of execution of the processing methods in the above embodiment is not necessarily limited to what was given in the above embodiment, and the order may be changed around without departing from the gist of the invention.

(E) In the above embodiment, a digital camera compatible with moving picture capture, and its camera body, were described as an example, but the technology described herein can also be applied to other image capturing devices, such as a digital video camera or a digital still camera. Thus, the technology disclosed herein can also be applied to image capturing devices compatible with only still picture capture, and to image capturing devices compatible with only moving picture capture.

The term “image capturing device” here is a concept that is not restricted to image capturing devices capable of imaging by themselves, and also encompasses a camera body. For example, “image capturing device” includes a camera body for an interchangeable lens type of camera to which an interchangeable lens unit can be mounted.

(F) In the above embodiment, the entire region of the touch panel 105 was set to be the inputtable region, but just part of the touch panel 105 may be set to be the inputtable region.

(G) In the above embodiment, the proximity detector was described using the infrared eye sensor 104 as an example, but the proximity detector can be any mechanism that can detect proximity between the electronic viewfinder 103 and an object. Therefore, the eye sensor 104 is not limited to being an infrared sensor, and may instead be an ultrasonic sensor, for example.

(H) In the above embodiment, the operating mode was switched on the basis of the pressing of the display switching button 106, but pressing does not necessarily have to be how the operating mode is switched. For instance, a lever used to switch the operating mode may be provided to the digital camera 1. In this case, the operating mode is switched on the basis of rotation of the lever.

### INDUSTRIAL APPLICABILITY

With the technology disclosed herein, accidental operation of a touch panel can be reduced, so the technology disclosed herein can be applied to digital cameras and other such image capturing devices, and is therefore useful.

### REFERENCE SIGNS LIST

100 camera body

103 electronic viewfinder

103a eyepiece

104 eye sensor

105 touch panel

106 display switching button

110 CCD image sensor

120 liquid crystal monitor

140 camera controller

200 interchangeable lens unit

1. An image capturing device, comprising:
an imaging section that captures an optical image of a subject and outputs image data;
a first display section that is configured to display a first image based on the image data;
a second display section that is configured to display a second image based on the image data;
a touch panel that is disposed over the surface of the second display section and is operable to undergo a first operation corresponding to the first image;
a proximity detector that can detect proximity between the first display section and an object; and
a controller that activates the first operation after the proximity detector has detected proximity between the first display section and an object, and that deactivates the first operation after the proximity detector has not detected proximity between the first display section and an object, when the touch panel has undergone the first operation.

2. The image capturing device according to claim 1,
wherein the touch panel is operable to undergo a second operation corresponding to the second image.

3. The image capturing device according to claim 1,
wherein the second display section stops its display when the touch panel has undergone the first operation.

4. The image capturing device according to claim 2,
wherein the controller is configured to control the touch panel so as to operate in a first mode or a second mode,
in the first mode, the touch panel undergoes the first operation, and
in the second mode, the touch panel undergoes the second operation.

5. The image capturing device according to claim 4,
wherein, when the touch panel is operating in the first mode, the controller activates the first operation after the proximity detector has detected proximity between the first display section and an object, and deactivates the first operation after the proximity detector has not detected proximity between the first display section and an object.

6. The image capturing device according to claim 4,
further comprising a switching interface that is operable to undergo operations,
wherein the controller switches between the first mode and the second mode on the basis of the operation inputted to the switching interface.

7. The image capturing device according to claim 6,
wherein the switching interface is a button switch.

8. The image capturing device according to claim 1,
wherein the first display section has an eyepiece.

9. The image capturing device according to claim 1,
wherein the first display section is a viewfinder.

10. A control method used in an image capturing device comprising:
an imaging section that captures an optical image of a subject and outputs image data;
a first display section that is configured to display a first image based on the image data;
a second display section that is configured to display a second image based on the image data; and
a touch panel that is disposed over the surface of the second display section,
the method comprising:
determining the proximity between the first display section and an object with the proximity detector when the touch panel has undergone a first operation corresponding to the first image;
activating the first operation with the controller after proximity has been detected by the proximity detector between the first display section and an object; and
deactivating the first operation with the controller after proximity has not been detected by the proximity detector between the first display section and an object.

11. A program used in an image capturing device comprising:
an imaging section that captures an optical image of a subject and outputs image data;
a first display section that is configured to display a first image based on the image data;
a second display section that is configured to display a second image based on the image data; and
a touch panel that is disposed over the surface of the second display section,
the program causing a computer to execute a control method comprising the steps of:
determining the proximity between the first display section and an object with the proximity detector when the touch panel has undergone a first operation corresponding to the first image;
activating the first operation with the controller after proximity has been detected by the proximity detector between the first display section and an object; and
deactivating the first operation with the controller after proximity has not been detected by the proximity detector between the first display section and an object.

12. An image capturing device comprising:
an imaging section capable of capturing an optical image of a subject and outputs image data;
an electronic viewfinder capable of displaying a first image based on the image data;
a display device capable of displaying a second image based on the image data;
a touch panel disposed over the surface of the display device and operable to undergo a first operation corresponding to the first image and a second operation corresponding to the second image;
a proximity detector that is configured to detect proximity between the electronic viewfinder and an object; and
a camera controller configured to:
display the second image on the display device and permit the second operation on the touch panel when the proximity detector has not detected proximity between the electronic viewfinder and the object; and
display the first image on the electronic viewfinder, deactivate the display of the second display on the display device and, only when the proximity detector has detected proximity between the electronic viewfinder and the object, permit the first operation on the touch panel.

13. An image capturing device, comprising:
an imaging section that captures an optical image of a subject and outputs image data;
a first display section that is configured to display a first image based on the image data;
a second display section that is configured to display a second image based on the image data;
a touch panel that is disposed over the surface of the second display section and is operable to undergo a first operation corresponding to the first image;
a proximity detector that can detect proximity between the first display section and an object
a switching interface that is operable to undergo operations to switch between display of the first display section and display of the second display section; and
a controller that activates the first operation after the proximity detector has detected proximity between the first display section and an object, and that deactivates the first operation after the proximity detector has not detected proximity between the first display section and an object, when the touch panel has undergone the first operation, in a case where the switching interface has undergone the operation to switch to display of the first display section.
